(19) United States
(12) Patent Application Publication
(10) Pub. No.: US 2009/0076924 A1
(43) Pub. Date: Mar. 19, 2009

(54) SELF-SERVICE TERMINAL WITH PASSPORT PHOTO PROCESSING

(76) Inventor: Doug Dina, Flowery Branch, GA (US)

Correspondence Address: PAUL W. MARTIN, NCR CORPORATION, LAW DEPT., 1700 S. PATTERSON BLVD., DAYTON, OH, 45479-0001, US

(21) Appl. No.: 11/855,702

(22) Filed: Sep. 14, 2007

(51) Int. Cl. G06Q 50/00; G06Q 30/00

(52) U.S. Cl. 705/24; 705/407

(57) ABSTRACT

A self-service terminal with passport photo processing. The self-service terminal includes a camera for capturing an image of a customer, a photo printer for printing a passport photo of the customer based upon the captured image, a payment acceptor for completing customer payment for the passport photo, a receipt printer for printing a receipt reflecting payment for the passport photo, a display for displaying instructions to the customer, an input device for recording customer selections, including a camera selection to activate the camera, an acceptance selection indicating acceptance of the image, and a photo printer selection to activate the photo printer, and a processor for causing the display to display first instructions informing the customer how to capture the image, for activating the camera in response to the camera selection, for displaying second instructions informing the customer how to judge the image, for recording the acceptance selection, for displaying third instructions informing the customer how to print the passport photo, for activating the photo printer in response to the printer selection, for recording a payment for the passport photo via the payment acceptor, and for activating the receipt printer to print the receipt.

### BACKGROUND

A typical passport customer must go to a photographer who specializes in taking passport photos.

It would be desirable to provide a self-service terminal with built in passport photo processing.

### SUMMARY

A self-service terminal with passport photo processing is provided.

The self-service terminal includes a camera for capturing an image of a customer, a photo printer for printing a passport photo of the customer based upon the captured image, a payment acceptor for completing customer payment for the passport photo, a receipt printer for printing a receipt reflecting payment for the passport photo, a display for displaying instructions to the customer, an input device for recording customer selections, including a camera selection to activate the camera, an acceptance selection indicating acceptance of the image, and a photo printer selection to activate the photo printer, and a processor for causing the display to display first instructions informing the customer how to capture the image, for activating the camera in response to the camera selection, for displaying second instructions informing the customer how to judge the image, for recording the acceptance selection, for displaying third instructions informing the customer how to print the passport photo, for activating the photo printer in response to the printer selection, for recording a payment for the passport photo via the payment acceptor, and for activating the receipt printer to print the receipt.

### BRIEF DESCRIPTION OF THE DRAWINGS

FIG. 1 is a block diagram of an example self-service terminal.

FIG. 2 illustrates an example embodiment of the self-service terminal.

FIG. 3 is a flow diagram illustrating operation of the self-service terminal.

### DETAILED DESCRIPTION

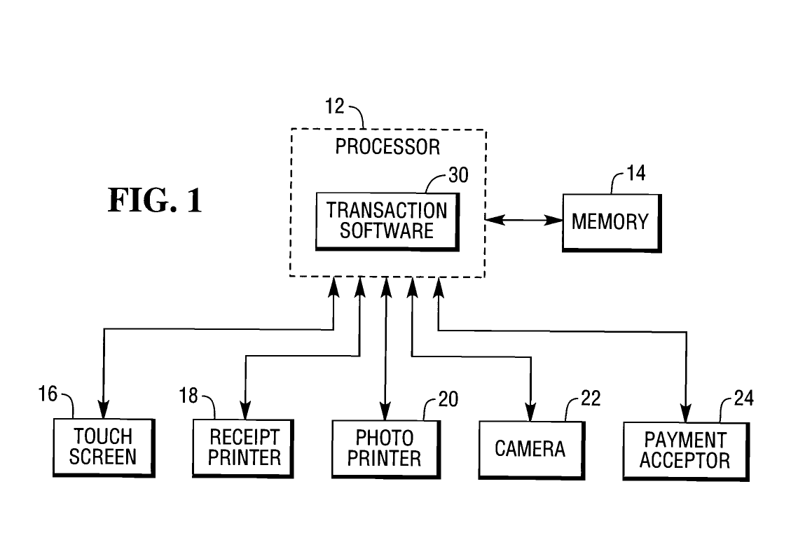

Referring now to FIG. 1, self-service terminal 10 includes processor 12, memory 14, and a number of peripherals, including touch screen 16, receipt printer 18, photo printer 20, camera 22, and payment acceptor 24.

Processor 12 executes transaction software 30. Transaction software 30 displays transaction options and instructions, records operator inputs, and controls operation of the peripherals.

For a passport photo transaction, transaction software 30 displays an interface including screens, instructions, and prompts that guide a customer through the transaction.

Memory 14 stores transaction software 30 and data used by transaction software 30.

Touch screen 16 displays the transaction options and instructions and records operator selections of options.

Receipt printer 18 prints a receipt following a transaction.

Photo printer 20 prints a passport photo during a passport photo transaction.

Camera 22 captures an image of a customer. Camera 22 is adjustable within a range of customer heights and capture angles.

Payment acceptor 24 accepts payment for transactions. Payment acceptor 24 may include separate or any combination of card reader, currency acceptor, currency dispenser, coin acceptor, coin dispenser, check reader, or other payment accepting device.

Self-service terminal 10 may additionally handle other transactions besides passport photo transactions.

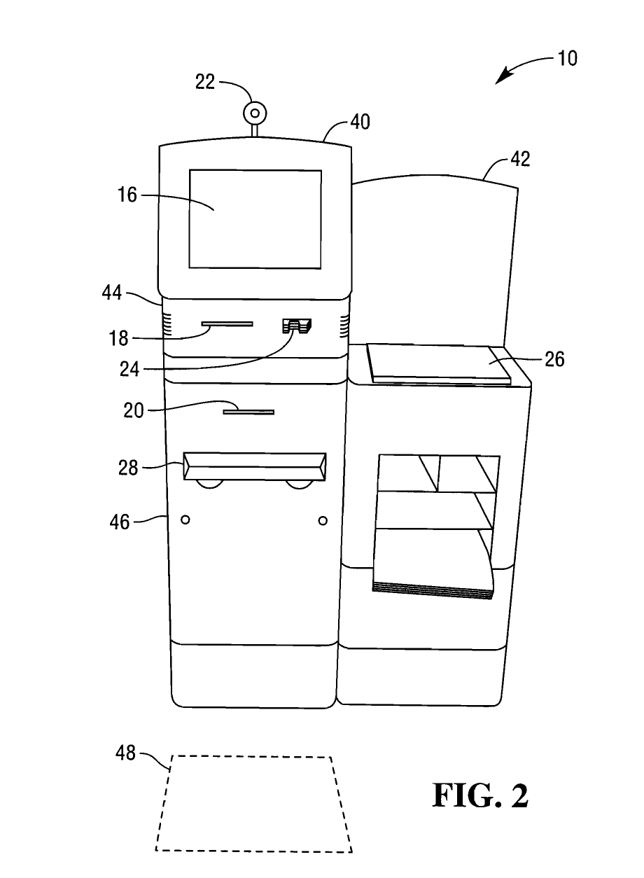

With reference to FIG. 2, an example embodiment of self-service terminal 10. In this example, self-service terminal 10 also operates as a postal kiosk, at which customers may weigh packages and envelopes, determine postage due, pay for postage due and supplies. For this purpose, self-service terminal includes postal scale 26 and postage dispenser 28 for dispensing postage due.

Transaction software 30 determines an amount of the postage based upon a weight of the package received from postal scale 26, records a payment for the postage via payment acceptor 24, and activates postage dispenser 28 to dispense the postage.

A customer may also select an amount of postage to purchase separately from package weighing via touch screen 16. Transaction software 30 records a payment for the postage via payment acceptor 24 and activates postage dispenser 28 to dispense the postage.

In an example embodiment, self-service terminal 10 includes a terminal portion 40 and a scale portion 42. Terminal portion 40 and scale portion 42 may be affixed together or located adjacent to one another with only scale signal and power connections.

Terminal portion 40 includes an upper section 44 and a lower section 46. In upper section 44, camera 22 is mounted on top of touch screen 16. Camera 22 may be affixed to a telescoping stand with height and capture angle retaining mechanisms, such as set screws. Touch screen 16 is located above receipt printer 18 and payment acceptor 24.

Lower section 46 includes photo printer 20 and postage dispenser 28.

During a passport photo transaction, transaction software 30 prompts a customer to stand at a predetermined location from camera 22, represented by square 48 on the floor in front of self-service terminal 10. Square 48 establishes customer at a proper focal distance from camera 22.

Depending upon the height of self-service terminal 10, a chair may also or alternatively be located in front of self-service terminal 10. Transaction software 30 may prompt a customer to sit on a chair or stool.

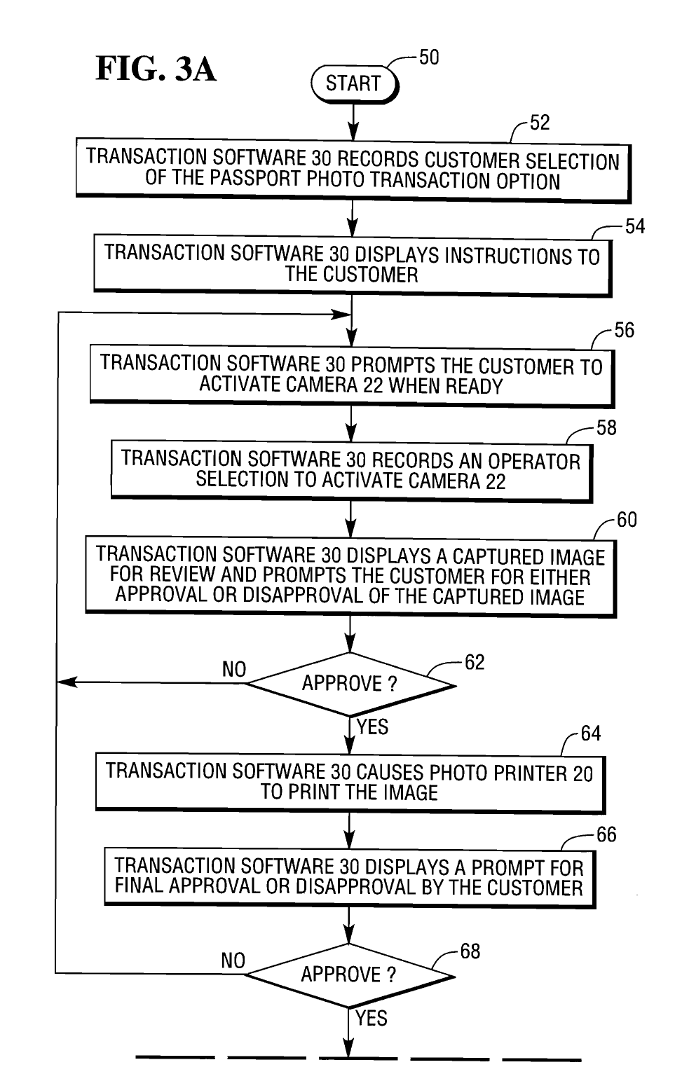

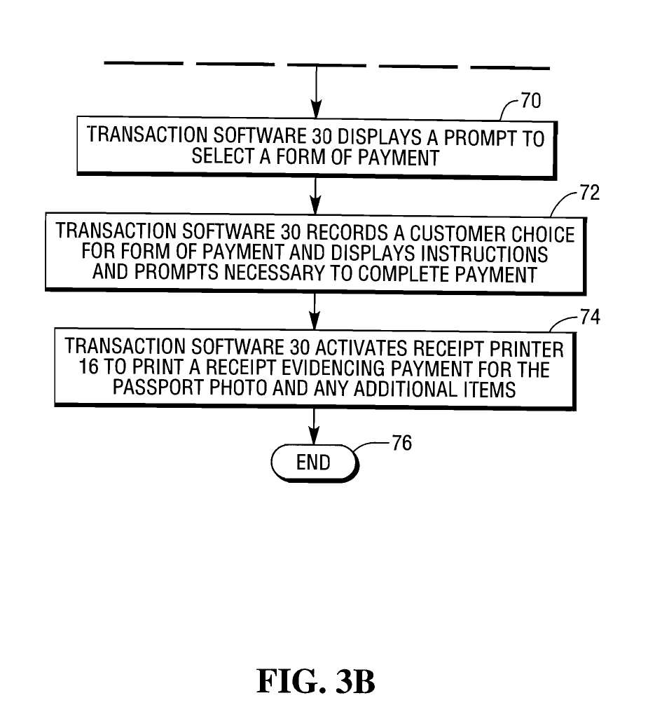

With reference to FIG. 3, an example process for completing a passport photo transaction is illustrated beginning with START 50.

In step 52, transaction software 30 displays a passport photo transaction option. Transaction software 30 may display other transaction options as well, and the passport photo transaction may be one of many transactions available.

In step 54, transaction software 30 records customer selection of the passport photo transaction option.

In step 56, transaction software 30 displays instructions to the customer, including where to stand or sit, how to adjust camera 22 height and/or angle, how the customer should center himself in the field of view of camera 22, how to activate camera 22, and how to determine whether a captured image satisfies government regulations.

In step 58, transaction software 30 prompts the customer to activate camera 22.

In step 60, transaction software 30 records an operator selection to activate camera 22. Transaction software 30 may allow a predetermined time period for the customer to reposition himself correctly.

In step 62, transaction software 30 displays a captured image for review and prompts the customer for either approval or disapproval of the captured image. Transaction software 30 may additionally display guidelines to assist the customer with the decision. For example, if the customer is not centered in the image or out of focus, transaction software 30 may display instructions to help remedy those problems.

In step 64, transaction software 30 records a customer selection either approving or disapproving a captured image. If the customer disapproves the captured image, operation returns to step 56. Otherwise, operation proceeds to step 64.

In step 66, transaction software 30 activates photo printer 20.

In step 68, transaction software 30 displays a prompt for final approval or disapproval of the printed photo by the customer. Transaction software 30 may additionally display guidelines to assist the customer with the decision.

In step 70, transaction software 30 records a customer selection either approving or disapproving a printed photo passport. If the customer disapproves the printed passport photo, operation returns to step 56. Otherwise, operation proceeds to step 72.

In step 72, transaction software 30 displays a prompt to select a form of payment. Transaction software 30 may additionally ask the customer whether the customer is finished with all transactions and ready to pay, or whether the customer wishes to conduct another transaction.

In step 72, transaction software 30 records a customer choice for form of payment and displays instructions and prompts necessary to complete payment. Payment terms may vary. For example, a customer may be required to pay for only the final photo, or all photos printed, whether acceptable or unacceptable. Transaction software 30 may alternatively prompt for a form of payment at the beginning of the transaction and limit the number of “failed” attempts before requiring additional payment.

In step 74, transaction software 30 records a payment choice and activates receipt printer 16 to print a receipt evidencing payment for the passport photo and any additional items.

Operation ends at step 76.

Although particular reference has been made to certain embodiments, variations and modifications are also envisioned within the spirit and scope of the following claims.

1. A self-service terminal comprising:
a camera for capturing an image of a customer;
a photo printer for printing a passport photo of the customer based upon the captured image;
a payment acceptor for completing customer payment for the passport photo;
a receipt printer for printing a receipt reflecting payment for the passport photo;
a display for displaying instructions to the customer;
an input device for recording customer selections, including a camera selection to activate the camera, an acceptance selection indicating acceptance of the image, and a photo printer selection to activate the photo printer; and
a processor for causing the display to display first instructions informing the customer how to capture the image, for activating the camera in response to the camera selection, for displaying second instructions informing the customer how to judge the image, for recording the acceptance selection, for displaying third instructions informing the customer how to print the passport photo, for activating the photo printer in response to the printer selection, for recording a payment for the passport photo via the payment acceptor, and for activating the receipt printer to print the receipt.

2. The self-service terminal of claim 1, wherein the display and the input device form a touch screen

3. The self-service terminal of claim 2, wherein the camera is affixed to a mount on top of the touch screen.

4. The self-service terminal of claim 3, wherein the mount includes adjustments for positioning the camera.

5. The self-service terminal of claim 4, wherein the first instructions include how to change the adjustments to facilitate capture of an acceptable image when the customer is located in a predetermined position in front of the camera.

6. The self-service terminal of claim 1, further comprising:
a postal scale for weighing packages; and
a postage dispenser for dispensing postage for the packages;
wherein the processor is also for determining an amount of the postage based upon a weight of the package received from the postal scale, for recording a payment for the postage via the payment acceptor, and for activating the postage dispenser to dispense the postage.

7. A self-service terminal comprising:
a first portion including a postal scale for weighing packages; and
a second portion including
a camera for capturing an image of a customer;
a photo printer for printing a passport photo of the customer based upon the captured image;
a payment acceptor for completing customer payment for the passport photo;
a receipt printer for printing a receipt reflecting payment for the passport photo;
a touch screen for displaying instructions to the customer and for recording customer selections, including a camera selection to activate the camera, an acceptance selection indicating acceptance of the image, and a photo printer selection to activate the photo printer;
a camera mount above the touch screen including adjustments for positioning the camera;
a postage dispenser for dispensing postage for the packages; and
a processor for causing the display to display first instructions informing the customer how to change the adjustments to facilitate capture of an acceptable image when the customer is located in a predetermined position in front of the camera, for activating the camera in response to the camera selection, for displaying second instructions informing the customer how to judge the image, for recording the acceptance selection, for displaying third instructions informing the customer how to print the passport photo, for activating the photo printer in response to the printer selection, for recording a payment for the passport photo via the payment acceptor, and for activating the receipt printer to print the receipt;
wherein the processor is also for recording another payment for the postage via the payment acceptor and for activating the postage dispenser to dispense the postage if the customer completes a postage transaction.

8. A method of completing a self-service passport transaction comprising:
recording a first customer selection of a passport photo transaction option by a self-service terminal;
displaying first instructions informing the customer how to change adjustments of a camera of a self-service terminal to facilitate capture of an acceptable image when the customer is located in a predetermined position in front of the camera by the self-service terminal;
activating the camera in response to a second customer selection by the self-service terminal;
displaying a captured image by the self-service terminal;
displaying second instructions informing the customer how to judge the captured image by the self-service terminal;
displaying third instructions informing the customer how to print a passport photo using a passport photo printer in response to a third customer selection accepting the captured image by the self-service terminal;
activating the passport photo printer in response to a fourth customer selection to print the captured image by the self-service terminal; and
recording a payment for the passport photo via a payment acceptor by the self-service terminal; and
activating a receipt printer to print a receipt evidencing payment for the passport photo.
